(19) United States
(12) Patent Application Publication
(10) Pub. No.: US 2026/0234460 A1
(43) Pub. Date: Aug. 13, 2026

(54) NANOMATERIAL-CONTAINING FRICTION REDUCER FOR WATER-BASED DRILLING FLUID, AND PREPARATION METHOD THEREFOR

(71) Applicant: China University of Petroleum (East China), Qingdao (CN)

(72) Inventors: Weian HUANG, Qingdao (CN); Yuqing ZHU, Qingdao (CN); Yu FAN, Qingdao (CN); Bo ZHAO, Qingdao (CN); Ziao LIU, Qingdao (CN); Zengbao WANG, Qingdao (CN); Hanyi ZHONG, Qingdao (CN); Lin JIANG, Qingdao (CN); Xin ZHAO, Qingdao (CN)

(21) Appl. No.: 19/445,654

(22) Filed: Jan. 12, 2026

(30) Foreign Application Priority Data
Feb. 11, 2025 (CN) 202510150021.X

(51) Int. Cl. C09K 8/035; C10M 101/04; C10N 10/04; C10N 10/06; C10N 10/12; C10N 10/16

(52) U.S. Cl. CPC C09K 8/035; C10M 101/04; C09K 2208/28; C10M 2201/062; C10M 2207/401; C10N 2010/04; C10N 2010/06; C10N 2010/12; C10N 2010/16

(57) ABSTRACT

The disclosure provides a nanomaterial-containing friction reducer for water-based drilling fluid, and a preparation method therefor. The method includes selecting rapeseed oil as a raw material of base oil, and introducing sulfur ions into a structure to prepare sulfurized rapeseed oil base oil; selecting aluminum oxide, ferric oxide and magnesium oxide to produce esterification, putting a friction reducer sample into a preheated water bath kettle, and adding glyceryl stearate to prepare an additive; adding N-hydroxysuccinimide (NHS) into N,N-dicyclohexylcarbodiimide (DCC), enabling the NHS to react with the DCC to generate active ester, and then adding the activated NHS into rapeseed oil containing nano-tungsten disulfide for stirring and reaction to prepare NHS-modified nano-tungsten disulfide; and adding the additive and the NHS-modified nano-tungsten disulfide into the sulfurized rapeseed oil base oil preheated in an oil bath kettle, and performing stirring for reaction to prepare the friction reducer for the water-based drilling fluid.

### TECHNICAL FIELD

The disclosure relates to the technical field of friction reducers for water-based drilling fluid, and particularly relates to a nanomaterial-containing friction reducer for water-based drilling fluid, and a preparation method therefor.

### BACKGROUND

Drilling fluid plays a vital role in drilling operation. It can not only carry rock fragments and cool drilling bits, but also stabilize wellbore walls and prevent drilling accidents.

However, with the increase in drilling depth, geological conditions at shaft bottoms become complicated. Specifically, the conditions such as temperature and pressure become increasingly harsh, and frictional resistance problems of the drilling fluid become increasingly prominent, greatly influencing drilling speeds and drilling efficiency.

In order to solve a problem of excessive frictional resistance of the drilling fluid, it is urgent to study and use a friction reducer. As a chemical substance capable of reducing a viscosity and frictional resistance of the drilling fluid, a friction reducer for water-based drilling fluid has gradually attracted widespread attention in the industry. By changing physical and chemical properties of the drilling fluid, the friction reducer can effectively reduce wear of a drilling bit and a drill pipe and improve a drilling speed. Thus, drilling time can be shortened, and drilling cost can be reduced.

In recent years, with development of unconventional oil and gas resources such as shale gas, requirements for a drilling fluid technology have become higher and higher. Remarkable progress has been made in a technology of high-performance water-based drilling fluid, where the friction reducer is a key component, and its performance is also constantly improving. Meanwhile, with increasingly strict environmental protection laws and regulations, environmental friendliness of the friction reducer has become the focus of research and development. Modern friction reducers gradually use degradable or hypotoxic raw materials to reduce environmental pollution.

The friction reducer for the water-based drilling fluid has been widely used for drilling fluid in the fields such as petroleum, natural gas, geothermy, and wells. It can effectively improve the drilling speed, and further can reduce wear of the drilling bit and drilling cost. Moreover, it plays an active role in reducing a shaft bottom temperature, stabilizing a wellbore wall, preventing drilling accidents, and other aspects.

A working principle of a nano friction reducer includes the following aspects: First, nanoparticles can form a stable dispersion system in drilling fluid through its unique size effect and surface effect, and improve lubrication performance of the drilling fluid. Second, the nanoparticles can penetrate into pores of a stratum and interact with pore walls to form one lubricating film. In this way, a friction coefficient between a drilling tool and the stratum can be reduced. Finally, the nanoparticles can form plugging layers in the pores of the stratum to prevent further leakage of the drilling fluid and protect a stratum environment.

The prior art has the following defects:

### 1. Performance Stability

A friction reducer for water-based drilling fluid needs to maintain stable performance during drilling, so as to ensure its continuous and effective reduction in frictional resistance. However, a liquid temperature of the drilling fluid will continue to rise during drilling fluid operation, and salts and acidic substances that may exist in the drilling fluid may have hydrothermal degradation effects on the friction reducer, resulting in its performance degradation. Thus, how to improve stability of the friction reducer in high temperature and complex chemical environments is an important technical problem.

### 2. Compatibility

A friction reducer needs to have desirable compatibility with other components (such as slurry and an inhibitor) in drilling fluid to ensure that overall performance of the drilling fluid is not influenced. If the friction reducer is incompatible with the other components, rheological behaviors and filtration of the drilling fluid may change, even leading to drilling accidents. Thus, studying compatibility of the friction reducer with the other components in the drilling fluid is the key to ensure effective application of the friction reducer.

### 3. Thermal Stability

In a high temperature drilling environment, thermal stability of a friction reducer becomes the critical factor affecting its performance. If the friction reducer decomposes or deteriorates at high temperature, it will not only lose its friction reducing effect, but also possibly have a negative impact on other properties of drilling fluid. Thus, how to improve the thermal stability of the friction reducer and keep its stable performance in the high temperature environment is another technical problem to be solved.

### 4. Environmental Friendliness

With increasingly strict environmental protection laws and regulations, environmental friendliness of drilling fluid has become an increasingly important consideration. As a significant part of the drilling fluid, a friction reducer for water-based drilling fluid needs attention for its environmental friendliness. A conventional friction reducer may contain chemical substances harmful to the environment, so it is the future development trend to develop an environmentally-friendly friction reducer to reduce its pollution and harm to the environment.

5. Coping with a Problem of Frictional Resistance Between a Drill String and Drilling Fluid

Friction between the drill string and the drilling fluid can easily produce great frictional resistance due to friction between solid and liquid, which affects normal drilling efficiency. At present, it is difficult to solve the friction between the drill string and the drilling fluid caused by rotation.

### SUMMARY

To solve problems that an existing friction reducer for water-based drilling fluid has poor environmental friendliness, friction reducing performance is unstable with change of drilling fluid types and drilling environments, and frictional resistance between a drill string and drilling fluid cannot be fundamentally solved, the disclosure provides a preparation method for a nanomaterial-containing friction reducer for water-based drilling fluid. The preparation method includes the following steps:
S1, selecting rapeseed oil as a raw material of base oil, and introducing sulfur ions into a structure through modification to prepare sulfurized rapeseed oil base oil;
S2, selecting aluminum oxide, ferric oxide and magnesium oxide to produce esterification under high-temperature catalysis, putting a friction reducer sample into a preheated water bath kettle, and adding glyceryl stearate prepared in advance to adjust a viscosity of the drilling fluid, so as to prepare an additive;
S3, adding N-hydroxysuccinimide into N,N-dicyclohexylcarbodiimide under water-bath heating, enabling the N-hydroxysuccinimide to react with the N,N-dicyclohexylcarbodiimide to generate active ester, and then adding the activated N-hydroxysuccinimide into rapeseed oil containing nano-tungsten disulfide for stirring and reaction under oil-bath heating to prepare N-hydroxysuccinimide-modified nano-tungsten disulfide; and
S4, slowly adding the additive obtained in S2 and the N-hydroxysuccinimide-modified nano-tungsten disulfide obtained in S3 into the sulfurized rapeseed oil base oil preheated in an oil bath kettle in proportion, and performing stirring for reaction to prepare the friction reducer for the water-based drilling fluid.

In an optional embodiment, in S2, a mass fraction of the aluminum oxide is 0.1%, a mass fraction of the ferric oxide is 0.02%, and a mass fraction of the magnesium oxide is 0.2%. A mass fraction of the glyceryl stearate is 7%.

In an optional embodiment, in S3, in a water bath at 80° C., the N-hydroxysuccinimide is added into the N,N-dicyclohexylcarbodiimide, and stirring is performed for reaction for 6 h at 500 r/min. Under oil-bath heating at 120° C., 10 ml of the activated N-hydroxysuccinimide is added into the rapeseed oil containing the nano-tungsten disulfide having a mass fraction of 20% for stirring and reaction for 6 h at 500 r/min, and the N-hydroxysuccinimide-modified nano-tungsten disulfide is prepared.

In an optional embodiment, in S4, the sulfurized rapeseed oil base oil is preheated to 120° C., and stirring is performed for reaction at 500 r/min for 6 h.

In an optional embodiment, in S2, an esterification equation is as follows:

XO+2R—COOH→(catalyst,heating)X(R—COO)₂+H₂O.

In an optional embodiment, in S1, the mass fractions of aluminum oxide powder, ferric oxide powder, magnesium oxide powder, the N-hydroxysuccinimide-modified nano-tungsten disulfide, and the glyceryl stearate are 0.1%, 0.02%, 0.2%, 5%, and 7%, respectively.

The disclosure further provides a nanomaterial-containing friction reducer for water-based drilling fluid prepared through the preparation method for a nanomaterial-containing friction reducer for water-based drilling fluid. Rapeseed oil is used as a raw material for preparing base oil. A main chain of a molecular structure of the friction reducer for the water-based drilling fluid is a C—C single bond structure, average bond energy of a C—C single bond is 347.3 kJ/mol, an S element is introduced into the structure through sulfuration to form an S═C═S or S≡C≡S bond, bond energy of a carbon-sulfur double bond is 536 kJ/mol, bond energy of a carbon-sulfur triple bond is 577 kJ/mol, and high-temperature-resistant sulfurized rapeseed oil is prepared. Meanwhile, Fe, Al and Mg elements are introduced into a polymer to form a metal bond and a covalent bond between carbon and metal, and a lubricating film is formed. Finally, N-hydroxysuccinimide-modified nano-tungsten disulfide is added.

Compared with the prior art, the disclosure has the following beneficial technical effects:
(1) The disclosure can greatly improve strength of the lubricating film by introducing the sulfur ions into a polymer structure. Meanwhile, sulfur can improve temperature resistance of the friction reducer, thus improving performance of the drilling fluid.
(2) By introducing metal ions into the polymer structure, the disclosure improves the strength and toughness of the lubricating film, reduces frictional resistance, and improves friction reducing performance of the drilling fluid and drilling efficiency.
(3) The rapeseed oil, a kind of plant oil, is selected as a material of the base oil, which can greatly prevent environmental pollution caused by use of mineral oil as a common friction reducer.
(4) Through innovative use of a nanomaterial and an N-hydroxysuccinimide (NHS) activation technology to improve dispersibility and adhesion of the nanomaterial on a surface of N80 steel, a frictional resistance problem between the drilling fluid and a surface of the drill string is greatly solved.

### BRIEF DESCRIPTION OF THE DRAWINGS

FIG. 1 shows an N80 steel sheet after adsorption in drilling fluid with a friction reducer containing no nano-additive.

FIG. 2 shows an N80 steel sheet after adsorption in drilling fluid with a friction reducer containing a nano-additive.

FIG. 3a shows a scanning electron microscope (SEM) result of adsorption in drilling fluid with a friction reducer containing no nano-additive (magnified by 1,000 times).

FIG. 3b shows an SEM result of adsorption in drilling fluid with a friction reducer containing no nano-additive (magnified by 10,000 times).

FIG. 4a shows an SEM result of adsorption in drilling fluid with a friction reducer containing a nano-additive (magnified by 1,000 times).

FIG. 4b shows an SEM result of adsorption in drilling fluid with a friction reducer containing a nano-additive (magnified by 10,000 times).

FIG. 5 shows change of a lubrication coefficient after addition of a friction reducer sample in different proportions.

### DETAILED DESCRIPTION OF THE EMBODIMENTS

Technical solutions in embodiments of the disclosure will be clearly and completely described below with reference to accompanying drawings in the embodiments of the disclosure. Obviously, the embodiments described are merely some embodiments rather than all embodiments of the disclosure. Based on the embodiments of the disclosure, all other embodiments obtained by those of ordinary skill in the art without any creative effort fall within the protection scope of the disclosure.

A molecular structure design of a friction reducer LZA-818 for water-based drilling fluid is based on the following principles: (1) A main chain uses a C—C single bond structure, and average bond energy of a C—C single bond is 347.3 kJ/mol, which is not easy to degrade at high temperature. (2) An S element is introduced into the structure to form an S═C═S or S═C═S bond, such that the bond energy is improved, that is, high temperature resistance is improved. (3) Fe, Al and Mg elements are introduced into a polymer, such that tensile strength and impact toughness can be enhanced, strength of a lubricating film can be improved, and meanwhile, thermal stability of the polymer can be improved. (4) When N-hydroxysuccinimide (NHS) activated ester is used to modify a nanomaterial, an NHS activated ester group can be introduced into a surface of the nanomaterial, such that adsorption of the nanomaterial on an N80 steel surface can be effectively improved. In addition, NHS modification can improve dispersibility of the nanomaterial in an aqueous solution.

### 1. Selection and Modification of Base Oil

Through an orthogonal experiment, from soybean oil, rapeseed oil, and white oil, the rapeseed oil is comprehensively selected as a raw material of the base oil according to physical and chemical properties, and indicators such as a lubrication coefficient and a viscosity of the drilling fluid after addition into the drilling fluid. However, because temperature resistance needs to be improved, it is necessary to introduce S ions into the structure through modification to prepare sulfurized rapeseed oil.

### 2. Screening of a Conventional Additive

Aluminum oxide, ferric oxide and magnesium oxide are selected, and optimal proportions of adding the aluminum oxide, the ferric oxide, and the magnesium oxide into the friction reducer are measured as 0.1%, 0.02%, and 0.2% through the orthogonal experiment. Meanwhile, the above materials are esterified under high-temperature catalysis, such that stability of the materials in the friction reducer is improved. A reaction equation is as follows:

XO+2R—COOH→(catalyst,heating)X(R—COO)₂+H₂O.

A friction reducer sample is put into a water bath kettle preheated to 80° C., and 7% of glyceryl stearate is added to adjust the viscosity and a shearing force of the drilling fluid.

### 3. Screening and Modification of a Nano-Additive

### 1) Material Selection

Nano-molybdenum disulfide and nano-tungsten disulfide are selected as alternative nanomaterials. In addition, through an orthogonal experiment, the nano-tungsten disulfide having better friction reducing performance is selected with an optimal dosage of 3%. Then, influence of a micro-shape of nano-tungsten disulfide particles on performance of the friction reducer is explored from a microscopic view, and spheroidal and flaky particles are selected as alternative conditions. Finally, it is determined that addition of spheroidal nano-tungsten disulfide having a mass fraction of 3% is most conducive to improvement in performance of the friction reducer.

### 2) Modification of Nano-Tungsten Disulfide

Firstly, NHS is added to N,N-dicyclohexylcarbodiimide (DCC) in a water bath at 80° C., and stirring is performed for reaction at 500 r/min for 6 h. The NHS reacts with the DCC to generate active ester. The active ester can react with compounds containing amino groups to form stable amide bonds. A function of the DCC is to promote activation of the NHS, such that the NHS can be combined with amino compounds more easily to form activated NHS. Then, under oil-bath heating at 120° C., 10 ml of the activated NHS is added into rapeseed oil containing the nano-tungsten disulfide having a mass fraction of 20% for stirring and reaction for 6 h at 500 r/min, and the NHS-modified nano-tungsten disulfide is prepared. Compared with an ordinary nano-tungsten disulfide solid, the NHS-modified nano-tungsten disulfide has greatly improved adsorption and dispersibility.

### (3) Preparation of a Nano Friction Reducer LZA-818 for Water-Based Drilling Fluid

The above conventional additives and nano-additive are slowly added into sulfurized rapeseed oil base oil in an oil bath kettle preheated to 120° C. according to dosages of mass fractions of 0.1% of aluminum oxide powder+0.02% of ferric oxide powder+0.2% of magnesium oxide powder+5% of NHS-modified nano-tungsten disulfide+7% of glyceryl stearate. Stirring is performed at 500 r/min for 6 h. Dark brown oily liquid is prepared as an LZA-818 friction reducer.

### 4. Performance Testing of the LZA-818 Friction Reducer

### (1) Testing of a Relationship Between Performance and a Dosage of LZA-818

The LZA-818 having mass fractions of 0.2%, 0.3%, 0.4%, 0.5% and 0.6% is added into 5.0% of freshwater slurry, and high-speed stirring is performed through a high-speed stirrer for 20 min at 10,000 r/min. Performance of the friction reducer before and after aging at 120° C./16 h is tested.

TABLE 2-1
Performance testing of LZA-818 with different dosages in freshwater slurry

| | | | | | | | | | | | Lubrication |
|---|---|---|---|---|---|---|---|---|---|---|---|
| | | | | | | | | | | | coefficient |
| | | Dosage/ | Gel | AV/ | PV/ | YP/ | ρ/g · | FLAPI/ | | Lubrication | reduction |
| Formula | Condition | % | (Pa/Pa) | mPa · s | mPa · s | Pa | cm − 3 | ml | pH | coefficient | rate |
| Freshwater | Before | / | 0.1 | 2.15 | 1.50 | 0.622 | 0.981 | 71.5 | 7 | 0.438 | / |
| slurry | aging | | | | | | | | | | |
| | After | / | 0.1 | 1.30 | 2.00 | 0.479 | 1.008 | 71.5 | 7 | 0.425 | 2.95 |
| | aging | | | | | | | | | | |
| Freshwater | Before | 0.5 | 0.1 | 2.30 | 1.60 | 0.670 | 0.986 | 70.3 | 7 | 0.354 | 19.27 |
| slurry + | aging | 1.0 | 0.3 | 2.35 | 1.60 | 0.718 | 0.998 | 69.7 | 7 | 0.323 | 26.30 |
| LZA-818 | | 1.5 | 0.4 | 2.55 | 2.00 | 0.527 | 1.028 | 67.5 | 7 | 0.307 | 29.93 |
| friction | | 2.0 | 0.5 | 2.60 | 1.80 | 0.718 | 1.097 | 66.2 | 7 | 0.253 | 42.18 |
| reducer | | 3.0 | 0.6 | 2.75 | 1.60 | 0.958 | 1.203 | 65.5 | 7 | 0.214 | 51.25 |
| | After | 0.5 | 0.1 | 1.35 | 1.10 | 0.239 | 1.021 | 68.5 | 7 | 0.398 | 12.45 |
| | aging | 1.0 | 0.1 | 1.50 | 1.40 | 0.096 | 1.265 | 67.9 | 7 | 0.355 | 22.05 |
| | | 1.5 | 0.1 | 1.90 | 1.90 | 0.082 | 1.297 | 66.5 | 7 | 0.329 | 27.73 |
| | | 2.0 | 0.1 | 2.00 | 2.00 | 0.060 | 1.358 | 64.7 | 7 | 0.307 | 32.53 |
| | | 3.0 | 0.1 | 2.05 | 2.00 | 0.048 | 1.569 | 59.9 | 7 | 0.233 | 48.69 |

From results shown in Table 2-1, it can be seen that the LZA-818 friction reducer improves lubricity of experimental slurry, and has moderate thermal stability. With increase in temperature, an ability of the friction reducer to improve lubricity decreases slightly. Shearing force data increases with increase in dosage of the LZA-818, and viscosity data increases slightly, indicating that strength of an internal reticular structure of fluid of the experimental slurry increases and strength of a lubricating film increases.

To sum up, the LZA-818 friction reducer can achieve an obvious friction reducing and lubrication effect, and can reduce frictional resistance. The friction reducing and lubrication effect is proportionate to dosages.

### 5. Testing of Temperature Resistance, Salt Resistance and Calcium Resistance of LZA-818

### (1) Temperature Resistance of LZA-818

Performance of the LZA-818 friction reducer added into 5.0% of freshwater slurry before and after aging at different temperatures is tested.

TABLE 2-2
Performance testing of LZA-818 friction reducer in freshwater
slurry before and after aging at different temperatures

| | | | | | | | | | | Lubrication |
|---|---|---|---|---|---|---|---|---|---|---|
| | | | | | | | | | | coefficient |
| | | Gel | AV/ | PV/ | | ρ/g · | | | Lubrication | reduction |
| Formula | Condition | (Pa/Pa) | mPa · s | mPa · s | YP/Pa | cm − 3 | FLAPI/ml | pH | coefficient | rate |
| Freshwater | Before | 0.1 | 2.15 | 1.50 | 0.624 | 0.981 | 71.5 | 7 | 0.438 | / |
| slurry | aging | 0.5 | 2.60 | 1.80 | 0.718 | 1.097 | 66.2 | 7 | 0.253 | 42.18 |
| Freshwater | | | | | | | | | | |
| slurry + 2% | | | | | | | | | | |
| LZA-818 | | | | | | | | | | |
| Freshwater | 120° C. | 0.1 | 1.30 | 1.52 | 0.478 | 1.008 | 73.5 | 7 | 0.356 | 2.95 |
| slurry | 150° C. | 0.1 | 1.25 | 1.40 | 0.410 | 1.019 | 77.8 | 7 | 0.214 | 51.20 |
| | 180° C. | 0.3 | 1.20 | 1.20 | 0.395 | 1.056 | 79.6 | 7 | 0.196 | 55.30 |
| | 200° C. | 0.4 | 0.95 | 1.05 | 0.233 | 1.086 | 85.5 | 7 | 0.082 | 81.17 |
| | 220° C. | 0.4 | 0.70 | 0.95 | 0.019 | 1.099 | 90.7 | 7 | 0.074 | 82.99 |
| Freshwater | 120° C. | 0.1 | 2.00 | 2.00 | 0.799 | 1.358 | 64.7 | 7 | 0.257 | 32.53 |
| slurry + 2% | 150° C. | 0.6 | 2.30 | 2.45 | 0.852 | 1.357 | 67.5 | 7 | 0.110 | 74.83 |
| LZA-818 | 180° C. | 0.8 | 2.80 | 3.00 | 0.866 | 1.380 | 70.2 | 7 | 0.092 | 78.91 |
| | 200° C. | 0.7 | 1.90 | 2.20 | 0.521 | 1.237 | 83.1 | 7 | 0.080 | 81.6 |
| | 220° C. | 0.3 | 1.40 | 1.55 | 0.452 | 1.156 | 89.2 | 7 | 0.076 | 82.54 |

Test results are shown in Table 2-2. After the LZA-818 friction reducer is added, a lubrication coefficient of experimental slurry decreases greatly before aging, and a reduction rate reaches 42.18%. The lubrication coefficient decreases rapidly when an aging temperature is between 120° C. to 150° C. Compared with the freshwater slurry, the lubrication coefficient reduction rate reaches 74.83%. To sum up, the LZA-818 has desirable temperature resistance and can maintain a relatively stable property in a high temperature environment under a shaft.

### (2) Testing of Salt Resistance and Calcium Resistance of a Nano Friction Reducer

A certain amount of freshwater slurry is taken, add 3% of the LZA-818 friction reducer is added. Stirring is performed at a high speed for 20 min, such that the experimental slurry is obtained. NaCl and CaCl₂) having gradient concentrations are added into the experimental slurry, high-speed stirring is continued for 20 min, the lubrication coefficient of the slurry is measured, and salt resistance and calcium resistance of the experimental slurry are measured and evaluated again after aging at 150° C. for 16 h.

TABLE 2-3
Performance testing of LZA-818 friction reducer in freshwater
slurry containing different concentrations and types of salts

| | | Gel | AV/ | PV/ | | ρ/g · | | Lubrication |
|---|---|---|---|---|---|---|---|---|
| Formula | Condition | (Pa/Pa) | mPa · s | mPa · s | YP/Pa | cm − 3 | FLAPI/ml | coefficient |
| Experimental | Before aging | 0.7 | 2.45 | 1.6 | 0.814 | 1.033 | 65.0 | 0.164 |
| slurry + 0% NaCl | 150° C. 16 h | 0.1 | 2.20 | 2.1 | 0.096 | 1.009 | 69.9 | 0.110 |
| Experimental | Before aging | 1.8 | 4.75 | 3.5 | 1.676 | 1.049 | 85.1 | 0.181 |
| slurry + 5% NaCl | 150° C. 16 h | 0.9 | 3.60 | 2.2 | 1.341 | 1.041 | 88.3 | 0.121 |
| Experimental | Before aging | 3.6 | 5.35 | 2.9 | 2.346 | 1.062 | 87.2 | 0.206 |
| slurry + 10% NaC1 | 150° C. 16 h | 2.1 | 4.80 | 2.8 | 1.915 | 1.053 | 92.5 | 0.181 |
| Experimental | Before aging | 12.5 | 4.45 | 3.6 | 2.538 | 1.082 | 90.1 | 0.217 |
| slurry + 15% NaCl | 150° C. 16 h | 9.9 | 4.95 | 2.4 | 2.442 | 1.093 | 96.1 | 0.194 |
| Experimental | Before aging | 0.1 | 1.90 | 1.7 | 0.192 | 1.010 | 69.9 | 0.206 |
| slurry + 0.1% CaCl₂ | 150° C. 16 h | 0.2 | 1.55 | 1.9 | 0.23 | 1.016 | 94.2 | 0.217 |
| Experimental | Before aging | 0.3 | 2.35 | 2.1 | 0.239 | 1.005 | 76.9 | 0.214 |
| slurry 1-5 + 0.3% CaCl₂ | 150° C. 16 h | 0.2 | 1.60 | 2.2 | 0.38 | 1.028 | 92.1 | 0.319 |
| Experimental | Before aging | 0.5 | 2.20 | 1.6 | 0.575 | 1.006 | 71.9 | 0.225 |
| slurry + 0.5% CaCl₂ | 150° C. 16 h | 0.3 | 1.80 | 2.4 | 0.38 | 1.011 | 85.7 | 0.330 |
| Experimental | Before aging | 0.6 | 1.70 | 0.9 | 0.766 | 1.012 | 83.7 | 0.239 |
| slurry + 1.0% CaCl₂ | 150° C. 16 h | 0.3 | 1.60 | 1.8 | 0.23 | 1.029 | 91.7 | 0.327 |

Experimental results are shown in Table 2-3. The lubrication coefficient of the experimental slurry before and after aging increases with increase in NaCl content, and a static shearing force and a dynamic shearing force of the experimental slurry increase. The reason is that after salt contamination, drilling fluid compresses a diffuse double layer of clay, such that a potential of the drilling fluid decreases, a hydration film becomes thinner, and a reticular structure is formed between clay particles. In this way, a shearing force increases. An apparent viscosity and a plastic viscosity of the experimental slurry remain stable, which are only slightly increased. Thus, a NaCl environment can influence performance of the LZA-818, and influence is positively correlated with concentration. Similar to test results of the NaCl influence, a CaCl₂) environment can influence performance of the LZA-818, and influence is positively correlated with concentration. However, influence on a friction reducing ability of the LZA-818 is less than that of the NaCl environment.

To sum up, the LZA-818 friction reducer has desirable salt resistance and calcium resistance.

### 6. Adsorption Test of Nanoparticles of an LZA-818 Friction Reducer

Two identical N80 steel sheets are taken and put into drilling fluid with a friction reducer containing no nano-additive and drilling fluid with a friction reducer containing a nano-additive for absorption for 4 h. After adsorption, components of the drilling fluid visible on surfaces are washed through deionized water and the surfaces are dried. The following results are obtained.

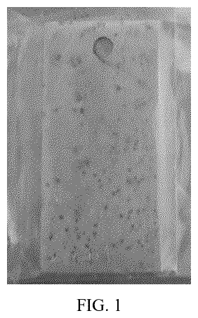

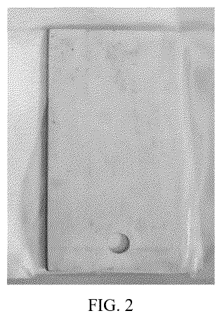

FIG. 1 and FIG. 2 show an N80 steel sheet after adsorption in the drilling fluid with the friction reducer containing no nano-additive and an N80 steel sheet after adsorption in the drilling fluid with the friction reducer containing the nano-additive, respectively.

A working principle of a scanning electron microscope (SEM) is as follows: focused high-energy electron beams scan a sample surface to generate various information (secondary electrons, backscattered electrons, transmitted electrons, absorbed electrons, etc.). The information is magnified by a detector reception and magnification unit and then fed back to a display. The electron beams and the display perform scanning synchronously to implement imaging. The scanning electron microscope is a common means for qualitative analysis of clay minerals because it can directly observe an original surface of a rock sample and has characteristics such as a great depth of field, a strong stereoscopic effect of an image, high resolution, and a great magnification. Thus, observation of types, crystal forms and attitudes of clay minerals through the scanning electron microscope is one of important means for reservoir evaluation and reservoir protection measure determination.

The scanning electron microscope may observe a form, a distribution, a property and a symbiotic combination of a solid surface, such that an adsorption situation and an adsorption form of a substance on the solid surface are analyzed, which is conducive to later comprehensive evaluation of adsorption.

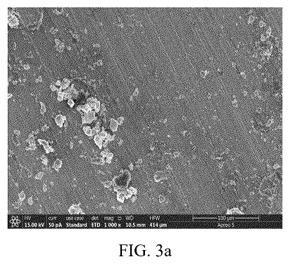

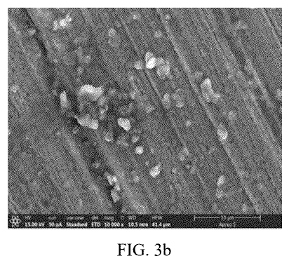

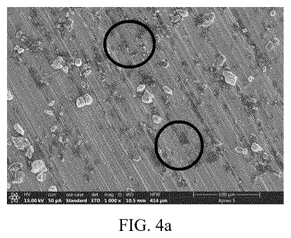

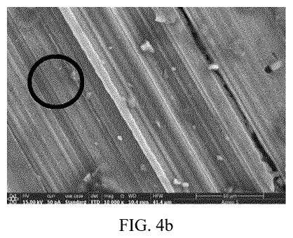

A microstructure on a surface of the N80 steel sheet is observed through a Hitachi S4800 cold-field emission scanning electron microscope. The test results are shown in FIG. 3 and FIG. 4.

It can be clearly seen from FIG. 3 that at a magnification of 1,000 times, the surface of the N80 steel sheet after adsorption in the drilling fluid with the friction reducer containing no nano-additive only has highlighted corrosion traces, and has no obvious modified nano-tungsten disulfide particles Meanwhile, at a magnification of 10,000 times, no obvious particle adsorption is observed.

Compared with FIG. 3, it can be clearly seen in FIG. 4 that at a magnification of 1,000 times, the surface of the N80 steel sheet after adsorption in the drilling fluid with the friction reducer containing the nano-additive has highlighted corrosion traces, and meanwhile obviously has a large number of modified nano-tungsten disulfide particles, which are densely distributed, with a distribution rate exceeding 90% and a net adsorption area exceeding 25%. Meanwhile, at a magnification of 10,000 times, more modified nano-tungsten disulfide particles can be seen.

Thus, the modified nano-tungsten disulfide can be easily adsorbed to the surface of the N80 steel sheet.

### 7. Performance Comparison of LZA-818 and a Common Friction Reducer

The LZA-818 is compared with a friction reducer having high temperature resistance, salt resistance and better performance at home and abroad in parallel. Performance of each friction reducer in corresponding slurry is tested at different aging temperatures. Four friction reducers having better performance are selected and added into experimental slurry 1-1 to 1-4 and 2-1 to 2-4, respectively, and the LZA-818 friction reducer is added into experimental slurry 1-5 and 2-5. Performance differences of the friction reducers are compared.

TABLE 2-4
Comparison of the performance of different types of traditional friction
reducers and LZA-818 friction reducer before and after aging

| | | | | | | | | | Lubrication |
|---|---|---|---|---|---|---|---|---|---|
| | | | | | | | | | coefficient |
| | | Gel | AV/ | PV/ | | ρ/g · | | Lubrication | reduction |
| Formula | Condition | (Pa/Pa) | mPa · s | mPa · s | YP/Pa | cm − 3 | FLAPI/ml | coefficient | rate |
| Slurry 1 | Before | 0.1 | 1.15 | 1.48 | 0.462 | 1.098 | 47.7 | 0.297 | / |
| | aging | | | | | | | | |
| | After | 0.1 | 1.03 | 1.22 | 0.399 | 1.101 | 42.5 | 0.233 | 24.75% |
| | aging | | | | | | | | |
| Experimental | Before | 0.0 | 1.25 | 1.60 | 0.335 | 1.016 | 23.1 | 0.227 | 6.73% |
| slurry 1-1 | aging | | | | | | | | |
| | After | 0.0 | 0.80 | 1.00 | 0.191 | 0.996 | 13.2 | 0.210 | 24.18% |
| | aging | | | | | | | | |
| Experimental | Before | 0.1 | 1.30 | 1.80 | 0.478 | 1.006 | 57.6 | 0.255 | 14.14% |
| slurry 1-2 | aging | | | | | | | | |
| | After | 0.1 | 1.00 | 1.10 | 0.095 | 0.995 | 47.2 | 0.201 | 21.18% |
| | aging | | | | | | | | |
| Experimental | Before | 0.0 | 1.50 | 1.80 | 0.287 | 1.009 | 49.5 | 0.244 | 17.85% |
| slurry 1-3 | aging | | | | | | | | |
| | After | 0.0 | 1.25 | 1.50 | 0.239 | 0.978 | 71.5 | 0.218 | 0.106% |
| | aging | | | | | | | | |
| Experimental | Before | 0.0 | 1.60 | 2.10 | 0.191 | 1.015 | 76.9 | 0.189 | 36.36% |
| slurry 1-4 | aging | | | | | | | | |
| | After | 0.0 | 0.75 | 0.90 | 0.143 | 0.952 | 87.2 | 0.177 | 11.11% |
| | aging | | | | | | | | |
| Experimental | Before | 0.0 | 2.10 | 2.00 | 0.095 | 0.997 | 62.9 | 0.196 | 34.06% |
| slurry 1-5 | aging | | | | | | | | |
| | After | 0.0 | 1.40 | 1.50 | 0.095 | 0.992 | 72.2 | 0.109 | 44.38% |
| | aging | | | | | | | | |
| Slurry 2 | Before | 10.1 | 28.55 | 6.90 | 20.73 | 1.200 | 59.1 | 0.301 | / |
| | aging | | | | | | | | |
| | After | 5.6 | 14.75 | 7.70 | 6.751 | 1.192 | 83.7 | 0.286 | 4.98% |
| | aging | | | | | | | | |
| Experimental | Before | 16.1 | 12.70 | 4.40 | 7.948 | 1.170 | 71.1 | 0.255 | 25.17% |
| slurry 2-1 | aging | | | | | | | | |
| | After | 9.5 | 4.90 | 3.30 | 4.563 | 1.113 | 99.57 | 0.241 | 5.49% |
| | aging | | | | | | | | |
| Experimental | Before | 14.5 | 30.05 | 11.80 | 17.42 | 1.169 | 94.5 | 0.235 | 18.53% |
| slurry 2-2 | aging | | | | | | | | |
| | After | 1.9 | 8.500 | 5.50 | 2.872 | 1.192 | 168.2 | 0.223 | 5.11% |
| | aging | | | | | | | | |
| Experimental | Before | 6.8 | 19.15 | 9.90 | 8.854 | 0.925 | 69.2 | 0.206 | 36.36% |
| slurry 2-3 | aging | | | | | | | | |
| | After | 2.7 | 5.59 | 7.60 | 8.632 | 0.736 | 89.6 | 0.182 | 11.65% |
| | aging | | | | | | | | |
| Experimental | Before | 12.9 | 14.80 | 5.70 | 8.714 | 1.216 | 90.5 | 0.172 | 42.85% |
| slurry 2-4 | aging | | | | | | | | |
| | After | 4.6 | 10.05 | 5.80 | 4.069 | 1.216 | 159.9 | 0.165 | 4.06% |
| | aging | | | | | | | | |
| Experimental | Before | 25.8 | 27.55 | 10.1 | 16.71 | 1.563 | 91.7 | 0.140 | 53.49% |
| slurry 2-5 | aging | | | | | | | | |
| | After | 5.4 | 14.56 | 7.20 | 7.134 | 1.579 | 100.2 | 0.132 | 5.71% |
| | aging | | | | | | | | |

According to Table 2-4, an LZA-818 friction reducer can obviously reduce a lubrication coefficient of drilling fluid in a freshwater environment. Meanwhile, when the LZA-818 friction reducer is added into the drilling fluid in the freshwater environment, values of a static shearing force and a dynamic shearing force of the drilling fluid are at a lower level in various friction reducers. That is, the LZA-818 friction reducer does not obviously improve internal structural strength of freshwater-based drilling fluid. However, after the LZA-818 friction reducer is added into the drilling fluid, an apparent viscosity and a plastic viscosity of the drilling fluid can increase obviously.

A lubrication coefficient of experimental slurry 2-5 with the LZA-818 friction reducer added into saline water slurry is a minimum value of each type of experimental slurry. The plastic viscosity is second only to that of experimental slurry 2-2, so the LZA-818 has a stronger lubricating film forming ability and stronger lubricating film strength in a saline water environment, and an effect of improving a lubricating ability of the drilling fluid is remarkable.

To sum up, the LZA-818 friction reducer has better performance in freshwater slurry and saline water slurry.

### 8. Testing of LZA-818 in Different Types of Drilling Fluid Systems

An LZA-818 friction reducer and four types of friction reducers having better performance are selected to test performance in polymer drilling fluid, polysulfonate drilling fluid, and high-performance environmentally-friendly drilling fluid, respectively, and comparison and analysis are performed.

### 1) Performance Comparison Test of LZA-818 and Conventional Drilling Fluid in a Polymer Drilling Fluid System

Deionized water, the LZA-818 and four common friction reducers are added into polymer drilling fluid systems 1 #and 2 #sequentially, with a dosage of 2%. Their performance differences are compared.

The experimental results are shown in Table 2-5.

TABLE 2-5
Performance comparison results of LZA-818 and conventional friction
reducer for drilling fluid in polymer drilling fluid system

| | | Gel | AV/ | PV/ | | ρ/ | | Lubrication | |
|---|---|---|---|---|---|---|---|---|---|
| Formula | Condition | (Pa/Pa) | mPa · s | mPa · s | YP/Pa | (g/cm3) | FLApr/ml | coefficient | PH |
| Experimental | After aging at | 1.533 | 48.75 | 26.57 | 22.74 | 1.099 | 3.5 | 0.31 | 10 |
| slurry 1-1 | 150° C. | | | | | | | | |
| Experimental | After aging at | 2.096 | 58.45 | 38.84 | 20.08 | 1.048 | 2.4 | 0.26 | 10 |
| slurry 1-2 | 150° C. | | | | | | | | |
| Experimental | After aging at | 2.862 | 46.05 | 27.05 | 19.45 | 1.097 | 2.7 | 0.29 | 10 |
| slurry 1-3 | 150° C. | | | | | | | | |
| Experimental | After aging at | 2.197 | 65.55 | 45.33 | 20.70 | 1.046 | 2.6 | 0.30 | 10 |
| slurry 1-4 | 150° C. | | | | | | | | |
| Experimental | After aging at | 2.913 | 44.15 | 28.06 | 16.51 | 1.051 | 3.0 | 0.28 | 10 |
| slurry 1-5 | 150° C. | | | | | | | | |
| Experimental | After aging at | 1.562 | 22.40 | 27.08 | 19.56 | 1.095 | 2.8 | 0.28 | 10 |
| slurry 1-6 | 150° C. | | | | | | | | |
| Experimental | After aging at | 0.408 | 15.85 | 12.95 | 3.014 | 1.037 | 5.9 | 0.39 | 10 |
| slurry 2-1 | 150° C. | | | | | | | | |
| Experimental | After aging at | 0.511 | 21.05 | 7.60 | 6.27 | 1.010 | 3.1 | 0.22 | 10 |
| slurry 2-2 | 150° C. | | | | | | | | |
| Experimental | After aging at | 0.613 | 21.85 | 7.80 | 14.36 | 1.078 | 3.7 | 0.32 | 10 |
| slurry 2-3 | 150° C. | | | | | | | | |
| Experimental | After aging at | 0.562 | 20.80 | 16.10 | 13.30 | 1.021 | 2.8 | 0.26 | 11 |
| slurry 2-4 | 150° C. | | | | | | | | |
| Experimental | After aging at | 0.613 | 25.00 | 18.40 | 6.75 | 1.005 | 3.7 | 0.25 | 10 |
| slurry 2-5 | 150° C. | | | | | | | | |
| Experimental | After aging at | 0.613 | 22.05 | 14.50 | 7.72 | 1.055 | 2.6 | 0.29 | 10 |
| slurry 2-6 | 150° C. | | | | | | | | |

It can be seen from Table 2-5 that performance of an LZA-818 friction reducer in polymer drilling fluid 1 #is better than that of a plurality of types of other conventional friction reducers for drilling fluid in the polymer drilling fluid 1 #in terms of lubrication coefficients. In an aspect of shearing forces, an ability to improve strength of an internal reticular structure of the drilling fluid after addition of the LZA-818 friction reducer is remarkable. Meanwhile, performance of the LZA-818 friction reducer in the polymer drilling fluid 1 #to improve strength of a lubricating film formed by the friction reducer is remarkable.

With the results, performance of the LZA-818 friction reducer in polymer drilling fluid 2 #is better. Test results of a shearing force and a viscosity can show that performance of the LZA-818 friction reducer to improve strength of an internal reticular structure of the drilling fluid and strength of the lubricating film is remarkable.

To sum up, the LZA-818 friction reducer has better adaptability in the polymer drilling fluid and a stronger friction reducing ability.

### 2) Performance Comparison Test of LZA-818 and a Conventional Friction Reducer in a Polysulfonate Drilling Fluid System

The LZA-818 and the conventional friction reducer are added into polysulfonate drilling fluid systems 1 #and 2 #, with a dosage of 2%.

The experimental results are shown in Table 2-6.

TABLE 2-6
Performance comparison results of LZA-818 and conventional friction
reducer for drilling fluid in polysulfonate drilling fluid system

| | | Gel | AV/ | PV/ | | ρ/ | | Lubrication | |
|---|---|---|---|---|---|---|---|---|---|
| Formula | Condition | (Pa/Pa) | mPa · s | mPa · s | YP/Pa | (g/cm3) | FLApr/ml | coefficient | PH |
| Experimental | After aging at | 3.69 | 42.26 | 39.53 | 5.53 | 1.061 | 11 | 0.33 | 11 |
| slurry 1-1 | 150° C. | | | | | | | | |
| Experimental | After aging at | 5.23 | 53.08 | 59.75 | 10.59 | 1.043 | 5.3 | 0.19 | 11 |
| slurry 1-2 | 150° C. | | | | | | | | |
| Experimental | After aging at | 3.26 | 49.75 | 56.42 | 6.357 | 1.103 | 7.2 | 0.29 | 11 |
| slurry 1-3 | 150° C. | | | | | | | | |
| Experimental | After aging at | 1.96 | 45.17 | 35.22 | 11.56 | 1.043 | 5.9 | 0.21 | 11 |
| slurry 1-4 | 150° C. | | | | | | | | |
| Experimental | After aging at | 3.89 | 50.23 | 48.78 | 5.79 | 1.037 | 5.1 | 0.25 | 11 |
| slurry 1-5 | 150° C. | | | | | | | | |
| Experimental | After aging at | 4.02 | 51.28 | 40.89 | 10.86 | 1.056 | 5.8 | 0.23 | 11 |
| slurry 1-6 | 150° C. | | | | | | | | |
| Experimental | After aging at | 2.452 | 52.25 | 46.87 | 5.57 | 1.069 | 8.2 | 0.32 | 11 |
| slurry 1-1 | 150° C. | | | | | | | | |
| Experimental | After aging at | 7.760 | 59.05 | 50.76 | 8.53 | 1.057 | 4.1 | 0.22 | 11 |
| slurry 1-2 | 150° C. | | | | | | | | |
| Experimental | After aging at | 3.525 | 55.75 | 50.46 | 5.47 | 1.097 | 5.4 | 0.25 | 11 |
| slurry 1-3 | 150° C. | | | | | | | | |
| Experimental | After aging at | 1.789 | 40.10 | 37.25 | 10.88 | 1.043 | 6.6 | 0.24 | 11 |
| slurry 1-4 | 150° C. | | | | | | | | |
| Experimental | After aging at | 2.503 | 52.45 | 46.10 | 6.48 | 1.040 | 3.9 | 0.26 | 11 |
| slurry 1-5 | 150° C. | | | | | | | | |
| Experimental | After aging at | 2.452 | 58.70 | 44.00 | 15.02 | 1.086 | 5.2 | 0.24 | 11 |
| slurry 1-6 | 150° C. | | | | | | | | |

It can be seen from Table 2-6 that an LZA-818 friction reducer has best adaptability and performance compared with a plurality of types of other conventional friction reducers for drilling fluid in polysulfonate drilling fluid 1 #in terms of lubrication coefficients. In an aspect of shearing forces, strength of an internal reticular structure of the LZA-818 friction reducer added into the polysulfonate drilling fluid 1 #is better than an effect of the plurality of types of other conventional friction reducers for drilling fluid in the polysulfonate drilling fluid 1 #. Performance of the LZA-818 friction reducer in the polysulfonate drilling fluid 1 #to improve strength of a lubricating film formed by the friction reducer is better. Similar to #1, a friction reducing ability of the LZA-818 friction reducer in polysulfonate drilling fluid 2 #is better. Test results of a shearing force and a viscosity can indicate that performance of the LZA-818 friction reducer in the polysulfonate drilling fluid 2 #to improve strength of an internal reticular structure of the drilling fluid and strength of the lubricating film is better than that of other types of friction reducers.

To sum up, the LZA-818 friction reducer has better adaptability in the polysulfonate drilling fluid and a stronger friction reducing ability.

3) A performance comparison test of LZA-818 and a conventional friction reducer in a high-performance environmentally-friendly drilling fluid system adds the LZA-818 and the conventional friction reducer into the high-performance environmentally-friendly drilling fluid system, with a dosage of 2%. The experimental results are shown in Table 2-7.

TABLE 2-7
Performance comparison results of LZA-818 and conventional drilling fluid
in high-performance environmentally-friendly drilling fluid system

| | | Gel | AV/ | PV/ | | ρ/ | | Lubrication | |
|---|---|---|---|---|---|---|---|---|---|
| Formula | Condition | (Pa/Pa) | mPa · s | mPa · s | YP/Pa | (g/cm3) | FLApr/ml | coefficient | PH |
| Experimental | After aging at | 1.963 | 37.23 | 20.15 | 19.63 | 1.069 | 10.5 | 0.32 | 10 |
| slurry 1-1 | 150° C. | | | | | | | | |
| Experimental | After aging at | 2.234 | 42.45 | 25.34 | 17.48 | 1.027 | 9.5 | 0.24 | 10 |
| slurry 1-2 | 150° C. | | | | | | | | |
| Experimental | After aging at | 2.861 | 40.97 | 24.13 | 17.17 | 1.078 | 6.9 | 0.29 | 10 |
| slurry 1-3 | 150° C. | | | | | | | | |
| Experimental | After aging at | 2.465 | 45.25 | 24.52 | 18.56 | 1.031 | 7.6 | 0.27 | 10 |
| slurry 1-4 | 150° C. | | | | | | | | |
| Experimental | After aging at | 2.032 | 41.59 | 23.65 | 16.15 | 1.040 | 7.9 | 0.28 | 10 |
| slurry 1-5 | 150° C. | | | | | | | | |
| Experimental | After aging at | 2.418 | 43.61 | 22.88 | 18.57 | 1.082 | 8.1 | 0.27 | 10 |
| slurry 1-6 | 150° C. | | | | | | | | |

It can be seen from Table 2-7 that an LZA-818 friction reducer in high-performance environmentally-friendly drilling fluid has better performance than a plurality of types of conventional friction reducers for drilling fluid in high-performance environmentally-friendly drilling fluid in terms of lubrication coefficients. An ability to improve strength of an internal reticular structure of the drilling fluid after addition of the LZA-818 friction reducer is remarkable. Performance of the LZA-818 friction reducer in the high-performance environmentally-friendly drilling fluid to improve strength of a lubricating film formed by the friction reducer is better than that of the plurality of types of conventional friction reducers for drilling fluid in the high-performance environmentally-friendly drilling fluid.

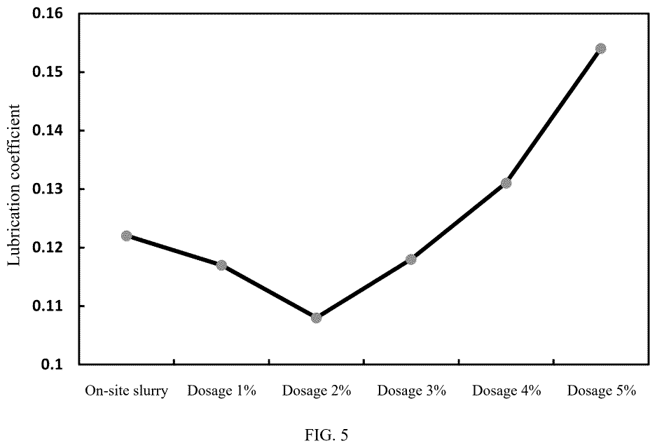

FIG. 5 shows change of a lubrication coefficient after friction reducer samples are used in a wulalike shale reservoir in different proportions. As shown in FIG. 5, a lubrication coefficient of on-site drilling fluid can be reduced by adding different proportions of friction reducer samples, with a lowest dosage of 2%, the lubrication coefficient decreases to 0.11 or below, and a desirable effect is achieved. However, due to a large number of solid phases in the friction reducer, the lubrication coefficient may increase if the dosage is excessive, so an optimal dosage is 2%. Meanwhile, during testing, the friction reducer sample has no influence on stability of a drilling fluid system, and does not influence reservoir protection and other properties of the drilling fluid system.

To sum up, the LZA-818 friction reducer has better adaptability and a stronger friction reducing ability in the high-performance environmentally-friendly drilling fluid.

For those skilled in the art, it is apparent that the disclosure is not limited to details of illustrative embodiments, and the disclosure can be implemented in other specific forms without departing from the spirit or basic features of the disclosure. Thus, the embodiments should be regarded as illustrative and nonrestrictive. The scope of the disclosure is defined by the appended claims rather than the description. Thus, it is intended to embrace all changes falling within meanings and the scope of equivalent elements of the claims in the disclosure. Any reference numeral in the claims should not be construed as limiting the related claims.

What is claimed is:

1. A preparation method for a nanomaterial-containing friction reducer for water-based drilling fluid, comprising the following steps:
S1, selecting rapeseed oil as a raw material of base oil, and introducing sulfur ions into a structure through modification to prepare sulfurized rapeseed oil base oil;
S2, selecting aluminum oxide, ferric oxide and magnesium oxide to produce esterification under high-temperature catalysis, putting a friction reducer sample into a preheated water bath kettle, and adding glyceryl stearate prepared in advance into the friction reducer to adjust a viscosity of the drilling fluid after the friction reducer is added into the drilling fluid, so as to prepare an additive;
S3, adding N-hydroxysuccinimide into N,N-dicyclohexylcarbodiimide under water-bath heating, enabling the N-hydroxysuccinimide to react with the N,N-dicyclohexylcarbodiimide to generate active ester, and then adding the activated N-hydroxysuccinimide into rapeseed oil containing nano-tungsten disulfide for stirring and reaction under oil-bath heating to prepare N-hydroxysuccinimide-modified nano-tungsten disulfide; and
S4, slowly adding the additive obtained in S2 and the N-hydroxysuccinimide-modified nano-tungsten disulfide obtained in S3 into the sulfurized rapeseed oil base oil preheated in an oil bath kettle in proportion, and performing stirring for reaction to prepare the friction reducer for the water-based drilling fluid.

2. The preparation method for a nanomaterial-containing friction reducer for water-based drilling fluid according to claim 1, wherein in S2, a mass fraction of the aluminum oxide is 0.1%, a mass fraction of the ferric oxide is 0.02%, and a mass fraction of the magnesium oxide is 0.2%; and a mass fraction of the glyceryl stearate is 7%.

3. The preparation method for a nanomaterial-containing friction reducer for water-based drilling fluid according to claim 1, wherein in S3, in a water bath at 80° C., the N-hydroxysuccinimide is added into the N,N-dicyclohexylcarbodiimide, stirring is performed for reaction for 6 h at 500 r/min, under oil-bath heating at 120° C., 10 ml of the activated N-hydroxysuccinimide is added into the rapeseed oil containing the nano-tungsten disulfide having a mass fraction of 20% for stirring and reaction for 6 h at 500 r/min, and the N-hydroxysuccinimide-modified nano-tungsten disulfide is prepared.

4. The preparation method for a nanomaterial-containing friction reducer for water-based drilling fluid according to claim 1, wherein in S4, the sulfurized rapeseed oil base oil is preheated to 120° C., and stirring is performed for reaction at 500 r/min for 6 h.

5. The preparation method for a nanomaterial-containing friction reducer for water-based drilling fluid according to claim 1, wherein in S2, an esterification equation is as follows:
XO+2R—COOH→(catalyst,heating)X(R—COO)₂+H₂O.

6. The preparation method for a nanomaterial-containing friction reducer for water-based drilling fluid according to claim 1, wherein in S1, the mass fractions of aluminum oxide powder, ferric oxide powder, magnesium oxide powder, the N-hydroxysuccinimide-modified nano-tungsten disulfide, and the glyceryl stearate are 0.1%, 0.02%, 0.2%, 5%, and 7%, respectively.

7. A nanomaterial-containing friction reducer for water-based drilling fluid prepared through the preparation method for a nanomaterial-containing friction reducer for water-based drilling fluid according to claim 1, wherein rapeseed oil is used as a raw material for preparing base oil; a main chain of a molecular structure of the friction reducer for the water-based drilling fluid is a C—C single bond structure, average bond energy of a C—C single bond is 347.3 kJ/mol, an S element is introduced into the structure through sulfuration to form an S═C═S or S═C═S bond, bond energy of a carbon-sulfur double bond is 536 kJ/mol, bond energy of a carbon-sulfur triple bond is 577 kJ/mol, and high-temperature-resistant sulfurized rapeseed oil is prepared; and meanwhile, Fe, Al and Mg elements are introduced into a polymer to form a metal bond and a covalent bond between carbon and metal, a high-strength lubricating film is formed, and finally, N-hydroxysuccinimide-modified nano-tungsten disulfide is added.
